(19) United States
(12) Patent Application Publication
(10) Pub. No.: US 2024/0159294 A1
(43) Pub. Date: May 16, 2024

(54) Damping Device for Reducing a Movement of a Second Component Movable Relative to a First Component

(71) Applicant: Illinois Tool Works Inc., Glenview, IL (US)

(72) Inventor: Christian BECK, Röttingen (DE)

(21) Appl. No.: 18/382,708

(22) Filed: Oct. 23, 2023

(30) Foreign Application Priority Data
Nov. 10, 2022 (DE) 10 2022 129 768.3

(51) Int. Cl. F16F 15/04

(52) U.S. Cl. CPC F16F 15/04

(57) ABSTRACT

Disclosed is a damper apparatus for dampening a movement of a second part movable relative to a first part. The damper apparatus includes a first damper component, a second damper component, and a dampening mechanism arranged between the first and second damper components. The second damper component is movable, at least partially or regionally, relative to the first damper component. The dampening mechanism reduces a movement of the second damper component relative to the first damper component. The damper apparatus includes a blade or rib structure connected to the first or second damper component with protruding regions, such as blades, ribs, or knobs. The protruding regions are elastically deflectable at least partially or regionally in the direction of movement of the first damper component relative to the second damper component. The dampening mechanism includes a ridge structure connected to the second or first damper component having at least one and preferably a plurality of teeth or protrusions. The tooth or protrusion of the ridge structure is arranged at least partially or regionally in an intermeshing manner between two adjacent protruding regions of the blade or rib structure.

### RELATED APPLICATION

The present application claims the benefit of German Patent Application No. 10 2022 129 768.3, filed Nov. 10, 2022, titled “Damping Device for Reducing a Movement of a Second Component Movable Relative to a First Component,” the contents of which are hereby incorporated by reference.

### BACKGROUND

The movement control apparatuses and damper apparatuses are used to reduce movement of a second part movable relative to a first part. Dampers have been developed in order to slow and/or control a relative movement of parts to one another. For example, vehicles are often equipped with various pivot assemblies (for example tailgates, freight doors, glove compartments, center console lids, engine hoods, etc.). The parts of pivot assemblies are connected to one another in order to rotate relative to one another, and one or more dampers are connected to the parts in order to regulate their rotational speed. Similarly, linear dampers are used to reduce a linear movement between two parts.

Certain known damper assemblies are designed so as to dampen the relative movement of parts that pivot due to gravity. If a part located further below (for example, a glove box flap) is released in order to pivot relative to a part located further above (for example, a dashboard), the damper slows the downwards rotation of the lower part.

Such damper apparatuses are often configured as air dampers or hydraulic dampers, in which a working fluid (air, hydraulic fluid, or grease) is forced from a first working space into a second working space through an orifice or choke, as a result of which a force/motion introduced into the damper is dampened. Rotary dampers are also known, whose functionality is based on the shear principle.

The known damper arrangements thus have a relatively complex construction, in which the sealing of the working spaces must be ensured. In particular, there is a risk that the systems will leak after some time and thus lose their dampening function. Moreover, damper apparatuses that operate with liquid working media, such as oils, have the disadvantage that the dampening behavior is often temperature-dependent, because the viscosity of the dampening liquid increases at low temperatures.

Despite advancements to date, a need exists for dampening apparatuses with a simple construction so that the dampening apparatuses can be manufactured and assembled inexpensively, while at the same time achieving a dampening capability that is as independent of temperature to the extent possible.

### SUMMARY

The present disclosure relates generally to a damper apparatus, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a top plan view, a first exemplary embodiment of the damper apparatus of the disclosure in the opened state, wherein the damper apparatus is configured as a rotary damper.

FIG. 2 illustrates schematically and in an isometric view, the first damper component of the exemplary embodiment of the damper apparatus according to the disclosure according to FIG. 1.

FIG. 3 illustrates schematically and in an isometric view, the second damper component of the exemplary embodiment of the damper apparatus according to the disclosure according to FIG. 1.

FIG. 4 illustrates schematically, an isometric view of a second exemplary embodiment of the damper apparatus of the disclosure in the opened state, wherein the damper apparatus is configured as a rotary damper.

FIG. 5 illustrates schematically, an isometric view of the first damper component of the second exemplary embodiment of the damper apparatus according to the disclosure according to FIG. 4.

FIG. 6 illustrates schematically, an isometric view of the second damper component of the second exemplary embodiment of the damper apparatus according to the disclosure according to FIG. 4.

FIG. 7 illustrates schematically and in an isometric view, a third exemplary embodiment of the damper apparatus according to the present disclosure, which is configured as a linear damper.

FIG. 8 illustrates schematically, an isometric view of the second damper component of the third exemplary embodiment of the damper apparatus according to the disclosure according to FIG. 7.

FIG. 9 illustrates schematically and in an isometric view, a fourth exemplary embodiment of the damper apparatus according to the present disclosure, which is configured as a linear damper.

FIG. 10 illustrates schematically, an isometric view of the fourth exemplary embodiment of the damper apparatus according to the present disclosure in the opened state.

FIG. 11 illustrates schematically, an isometric view of the first damper component of the fourth exemplary embodiment of the damper apparatus according to the disclosure according to FIG. 9.

FIG. 12 illustrates schematically, an isometric view of the second damper component of the fourth exemplary embodiment of the damper apparatus according to the disclosure according to FIG. 9.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure addresses the problem of specifying a damper apparatus for dampening the movement of a part, which offers a wide range of possible uses. In particular, there is a need for dampening apparatuses with a simple construction so that the dampening apparatuses can be manufactured and assembled inexpensively, while at the same time achieving a dampening capability that is as independent of temperature to the extent possible.

This problem is solved according to the disclosure by damper apparatus according to the independent claim 1, wherein advantageous further developments of the damper apparatus according to the disclosure are specified in the dependent claims.

Accordingly, the present disclosure relates in particular to a damper apparatus for reducing a movement of a second part movable relative to a first part, wherein the damper apparatus comprises a first damper component, which is in particular fixedly connected or connectable to the first part, and a second damper component, which is in particular fixedly connected or connectable to the second component, wherein the second damper component is movable, at least partially or regionally, relative to the first damper component.

The damper apparatus further comprises a dampening mechanism arranged between the first and second damper components and configured such that a movement of the second damper component relative to the first damper component is or can be reduced (dampened).

According to the disclosure, it is provided in particular that the dampening mechanism comprises a blade or rib structure connected to the first or second damper component with a plurality of protruding regions, for example blades, fingers, knobs, and/or ribs, which are elastically deflectable at least partially or regionally in the direction of movement of the first damper component relative to the second damper component.

Additionally, the dampening mechanism comprises a ridge structure connected to the second or first damper component having at least one and preferably at least a plurality of teeth or protrusions, wherein, at least in a state in which the second damper component is not moved relative to the first damper component, the at least one tooth or protrusion of the ridge structure is arranged at least partially or regionally in an intermeshing manner between two adjacent protruding regions of the blade or rib structure.

The advantages achievable with the damper apparatus according to the disclosure are obvious: by providing that the functionality of the dampening mechanism is not based on the displacement of a working fluid, in particular a hydraulic fluid (oil), or on a gas, in particular air, the dampening mechanism is much simpler to implement in a constructive sense, wherein at the same time, in a particularly efficient manner, a dampening characteristic of the damper apparatus can be adjusted, in particular individually, i.e., user-specific. Moreover, the dampening characteristic of the damper apparatus is largely independent of ambient conditions, in particular temperature.

According to realizations of the damper apparatus according to the disclosure, it is provided in this context that the at least one tooth or protrusion of the ridge structure is positioned (e.g., arranged and/or formed) between two movable and/or adjacent protruding regions of the blade or rib structure such that, upon a movement of the first or second damper component relative to the second or first damper component, at least a portion of the protruding regions of the blade or rib structure is elastically deformed using the at least one tooth or protrusion of the ridge structure while simultaneously converting movement energy into deformation work.

In other words, the dampening mechanism relies on a functionality in which at least a portion of the initiated kinetic energy is converted into thermal energy by elastic deformation. Preferably, the protruding regions of the blade or rib structure are formed from an elastic material, in particular a plastic material, whose elasticity varies only slightly over a temperature range, as far as possible.

Alternatively or additionally, it is preferred that the at least one tooth or protrusion of the ridge structure is formed from a material, in particular a plastic material, that is harder compared to the material of the protruding regions of the blade or rib structure.

According to a further aspect, the solution according to the disclosure is in particular wherein the protruding regions of the blade or rib structure, when viewed in the cross-section of the protruding regions, have a geometry that at least partially or regionally tapers, in particular conically tapers, in the direction of the ridge structure.

Alternatively or additionally, according to the further aspect of the disclosure, it can be provided that the at least one tooth or protrusion of the ridge structure, when viewed in the cross-section of the at least one tooth or protrusion, has a geometry that at least partially or regionally tapers, in particular conically tapers, in the direction of the blade or rib structure.

With this measure, it is ensured that the protruding regions of the blade or rib structure unilaterally impact the at least one tooth or protrusion of the ridge structure, whereby a harmonic transmission of force is realized.

In this context, in accordance with design variants of the damper apparatus according to the disclosure, it is provided in particular that the at least one tooth or protrusion of the ridge structure has a shape that is at least regionally at least substantially complementary to the shape of the protruding regions of the blade or rib structure.

This is an easy-to-implement, yet effective measure in order to ensure a harmonic transmission of force between the ridge structure and the blade or rib structure. Such a harmonic transmission of force implies a homogeneous force curve and a flat force amplitude, as a result of which any noises can also be prevented or at least reduced when the dampening mechanism responds.

According to preferred realizations of the damper apparatus according to the disclosure, it is provided that the blade or rib structure comprises a blade or rib support, in particular fixedly connected to the first or second damper component, as well as the protruding regions connected to the blade or rib support.

In this context, it can be appreciated that the blade or rib support is formed from a material, in particular a plastic material, that is harder compared to the material of the protruding regions. Preferably, the blade or rib structure is formed as part of a two-part plastic injection molding process. This further reduces the cost of manufacture of the damper apparatus according to the disclosure.

According to design variants of the damper apparatus according to the disclosure, it is provided that, in the unloaded state, in particular in a state in which the second damper component is not moved relative to the first damper component, at least a portion of the protruding regions of the blade or rib structure extends at least substantially in a direction that is at least substantially perpendicular to the direction of movement of the second damper component relative to the first damper component.

Alternatively or additionally, it can be provided that the at least one tooth or protrusion of the ridge structure should preferably extend at least substantially in a direction which is at least substantially perpendicular to the direction of movement of the second damper component relative to the first damper component.

In order to produce a differentiated and in particular direction-based damper characteristic, it is contemplated that, in the unloaded state, in particular in a state in which the second damper component is not moved relative to the first damper component, at least a portion of the protruding regions of the blade or rib structure extends at least substantially obliquely in view of a direction that extends perpendicular to the direction of movement of the second damper component relative to the first damper component.

Here, the at least one tooth or protrusion of the ridge structure should preferably extend at least substantially in a direction which is at least substantially perpendicular to the direction of movement of the second damper component relative to the first damper component.

Of course, it is also contemplated that the at least one tooth or protrusion of the ridge structure is arranged so as to extend obliquely.

The dampening characteristic of the damper apparatus can be adjusted in a particularly simple yet effective manner, in particular for a specific application, by varying the number of teeth or protrusions of the ridge structure as well as the number of ribs or blades of the blade or rib structure.

According to preferred design variants of the damper apparatus according to the disclosure, it is provided in this context that the ridge structure is configured such that a plurality of protruding regions of the blade or rib structure are arranged between two adjacent teeth or protrusions of the ridge structure.

In this context, it is also contemplated in particular that a number of the protruding regions of the blade or rib structure between two adjacent teeth or protrusions of the ridge structure varies, or a number of the teeth or protrusions of the ridge structure between two adjacent protruding regions of the blade or rib structure varies.

With this measure, it is possible in an easily realized but nevertheless effective manner that a permanent deformation of the elastically deformable protruding regions of the blade or rib structure is avoided upon stress or during operation of the damper apparatus, wherein simultaneously all elastically deformable protruding regions of the blade or rib structure are simultaneously and uniformly stressed.

A further particularity of the damper apparatus according to the disclosure can be seen in the fact that the first and/or second damper component is/are of modular construction.

The modularity of the structure can be seen in particular in the fact that the blade or rib structure and/or the ridge structure is/are exchangeable as needed and in particular for varying a response behavior and/or a dampening factor of the damper apparatus.

This offers the decisive advantage that the damper apparatus can be adapted in a particularly straightforward manner to specific applications by simply exchanging the blade or rib structure and/or the ridge structure.

According to contemplated realizations of the damper apparatus, it is configured as a rotary damper.

In particular, it is provided that the first damper component is configured as a housing part having an inner well region that is substantially circular-cylindrical in cross section. The housing part with the inner well region serves as a blade or rib support, to which or at which the protruding regions of the blade or rib structure are connected or formed.

In this context, it is contemplated in particular that the second damper component of the damper apparatus comprises a carrier part that is at least substantially circular-cylindrical in cross-section, which forms the ridge structure with the at least one tooth or protrusion and is at least partially or regionally accommodated in the inner well region of the first damper component, preferably in an exchangeable manner such that the carrier part with the ridge structure is rotatable relative to the first damper component, while the at least one tooth or protrusion of the ridge structure is arranged at least partially and/or regionally in an intermeshing manner between two adjacent protruding regions of the blade or rib structure.

Alternatively, it is contemplated that the damper apparatus is configured as a rotary damper, in which the first damper component is configured as a housing part having an inner well region that is at least substantially circular-cylindrical in cross-section, wherein the housing part with the inner well region serves as a carrier part which forms the ridge structure with the at least one tooth or protrusion, wherein the second damper component comprises a blade or rib support that is at least substantially circular-cylindrical in cross-section, to which or at which the protruding regions of the blade or rib structure are connected or formed, wherein the circular-cylindrical blade or rib support with the blade or rib structure is at least partially or regionally accommodated in the inner well region of the first damper component, preferably in an exchangeable manner such that the carrier part with the ridge structure is rotatable relative to the first damper component, while the at least one tooth or protrusion of the ridge structure is arranged at least partially and/or regionally in an intermeshing manner between two adjacent protruding regions of the blade or rib structure.

In this context, it is expedient that the first damper component comprises an annular region, which is formed in the circular-cylindrical inner well region such that the inner well region is divided into an outer annular channel and a region that is circular in cross-section and is separated therefrom by the annular region, wherein the teeth or protrusions of the ridge structure are formed on the wall bordering the outer annular channel and on the wall of the annular region facing inward, and wherein the second damper component further comprises an annular blade or rib support, which is arranged so as to complement the outer annular channel of the first damper component in such a way that the annular blade or rib support can be at least partially or regionally accommodated in the outer annular channel of the first damper component, wherein protruding regions of the blade or rib structure are connected or formed to or at the annular blade or rib support on both sides.

Alternatively, however, it is also contemplated that the damper apparatus is designed as a linear damper.

In order to realize such a linear damper, it is expedient that the first damper component of the damper apparatus is configured as a cylindrical housing part with a cavity that is at least substantially circular-cylindrical in cross-section, wherein the housing part serves as a blade or rib support, to which or at which the protruding regions of the blade or rib structure are connected or formed.

In this context, it is expedient that that the second damper component of the damper apparatus comprises a piston that dips at least partially or regionally into the cavity of the cylindrical housing part and comprises a piston rod having a first end region at which a carrier part with the ridge structure that is substantially circular-cylindrical in cross-section is arranged or formed.

In this case, the piston with the carrier part and the ridge structure should be displaceable in the longitudinal direction of the cylindrical housing part relative to the cylindrical housing part, while the at least one tooth or protrusion of the ridge structure is arranged at least partially and/or regionally in an intermeshing manner between two adjacent protruding regions of the blade or rib structure.

According to further developments of the last mentioned embodiment, in which the damper apparatus is configured as a linear damper, it is provided that the at least one tooth or protrusion of the ridge structure is configured as a screw-like structure, in particular a helix structure, being formed at least partially or regionally on the lateral surface of the circular-cylindrical carrier part. Of course, however, other embodiments for the configuration of the ridge structure are possible as well.

According to a further alternative design variant of the damper apparatus according to the disclosure, it is configured as a linear damper, in which the first damper component comprises two opposing blade or rib supports, which are configured so as to form a preferably form-fit and even more preferably at least partially or regionally form-fit sliding guide enabling the translation for a rod-shaped carrier part of the second damper component.

Here, it is preferably provided that each blade or rib support of the first damper component comprises a blade or rib structure having a plurality of protruding regions. On the other hand, the rod-shaped carrier part of the second damper component should comprise a ridge structure having a plurality of teeth or protrusions arranged on opposite lateral surfaces of the rod-shaped carrier part in such a way that, when the rod-shaped carrier part is moved by the sliding guide, with simultaneous elastic deflection of the protruding regions, they pass by one another, in particular in an intermeshing manner.

According to a further development of the last mentioned design variant of the damper apparatus according to the disclosure, it is provided that a distance between the two opposing blade or rib supports is preferably variable in order to thus define a dampening factor of the damper apparatus.

In this context, it is contemplated in particular that the two blade or rib supports opposite one another are in a pre-stressed state with the aid of a spring element or with the aid of spring elements. Likewise, a free-wheel function of the damper apparatus configured as a linear damper can be realized.

Alternatively or additionally, it is contemplated that at least one of the two blade or rib supports lying opposite one another is slidably mounted relative to the rod-shaped carrier portion by way of a guide running obliquely to the direction of movement of the rod-shaped carrier part, and namely in particular such that, upon a movement of the rod-shaped carrier part in a first direction by the sliding guide, the at least one blade or rib support is present in a first position, and, upon a movement of the rod-shaped carrier part in a second direction opposite the first direction by the sliding guide, the at least one blade or rib support is displaced into a second position and/or is present in a second position, wherein, in the second position of the at least one blade or rib support, a distance between the two opposing blade or rib supports is greater than in the first position of the at least one blade or rib support. The distance between the two opposing blade or rib supports in the second position can in particular be selected such that a free-wheeling of the rod-shaped carrier part is possible due to the sliding guide.

The disclosure further relates to the use of the aforementioned damper apparatus as a movement control apparatus for reducing a movement of a second part movable relative to a first part.

In addition, the disclosure relates to a vehicle component, in particular an interior vehicle component, which comprises two components that can be moved relative to one another, wherein a relative movement of these components is dampened or reduced with the aid of an aforementioned type.

The exemplary embodiments of the damper apparatus 1 according to the disclosure shown in the drawings relate to movement control apparatuses for controlling and in particular reducing a movement of a second part movable relative to a first part. In the drawings, the first part and the second part are not shown.

The exemplary embodiments of the damper apparatus 1 according to the disclosure each comprise a first damper component 2, which is in particular fixedly connected or connectable to the first part (not shown in the drawings), as well as a second damper component 3, which is in particular fixedly connected or connectable to the second part (not shown in the drawings). The second damper component 3 is movable relative to the first damper component 2, at least partially or regionally.

In addition, in the exemplary embodiments shown in the drawings, a dampening mechanism is provided, which is arranged between the first and second damper components 2, 3 and configured such that a movement of the second damper component 3 relative to the first damper component 2 is or can be dampened.

The dampening mechanism, which is used in the exemplary embodiments of the damper apparatus 1 according to the disclosure shown schematically in the drawings, is in particular characterized in that it is simple in construction and, in particular, the functionality of the dampening mechanism is not based on a displacement of a fluid caused in order to reduce a movement.

As a result, the construction of the damper apparatus 1 can be significantly simplified, because it does not depend on a suitable sealing of corresponding work spaces for the working fluid.

Rather, in the exemplary embodiments of the damper apparatus 1 according to the disclosure shown in the drawings, it is provided that the dampening mechanism comprises a blade or rib structure 4 connected to the first or second damper component 2, 3 and having a plurality of protruding regions, here in the form of blades or ribs. The blades or ribs of the blade or rib structure 4 of the first or second damper component 2, 3 are at least partially or regionally elastically deflectable relative to the second or first damper component 3, 2.

The dampening mechanism used in the exemplary embodiments of the damper apparatus 1 according to the disclosure shown in the drawings is further characterized in that the dampening mechanism comprises a ridge structure having at least one tooth or protrusion associated with the damper component 2, 3 and not equipped with the blade or rib structure 4. It is provided that, in a state in which the second damper component 3 is not moved relative to the first damper component 2, the at least one tooth or protrusion of the ridge structure 5 is arranged at least partially or regionally in an intermeshing manner between two adjacent blades or ribs of the blade or rib structure 4.

It can be seen from the exemplary embodiments of the damper apparatus 1 according to the disclosure shown in the drawings that the blades or ribs of the blade or rib structure 4, when viewed in the cross-section of the blades or ribs, can have a geometry that at least partially or regionally tapers, in particular conically tapers, in the direction of the ridge structure 5.

In this context, it is additionally or alternatively possible that the at least one tooth or protrusion of the ridge structure 5, when viewed in the cross-section of the at least one tooth or protrusion, has a geometry that at least partially or regionally tapers, in particular conically tapers, in the direction of the blade or rib structure 4.

The exemplary embodiments of the damper apparatus 1 according to the disclosure shown in the drawings have a modular construction in which the first and second damper components 3 overall form a housing. The first and second damper components 3 can be connected to one another, in particular latched by means of a clip connection.

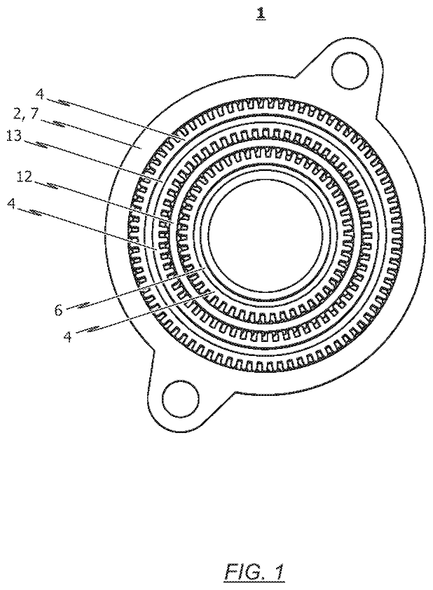

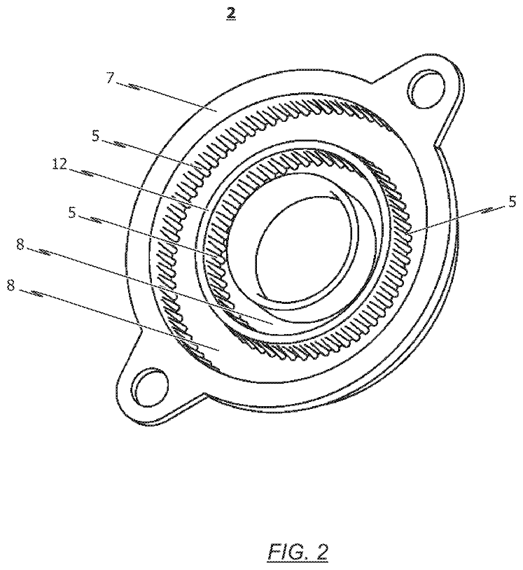

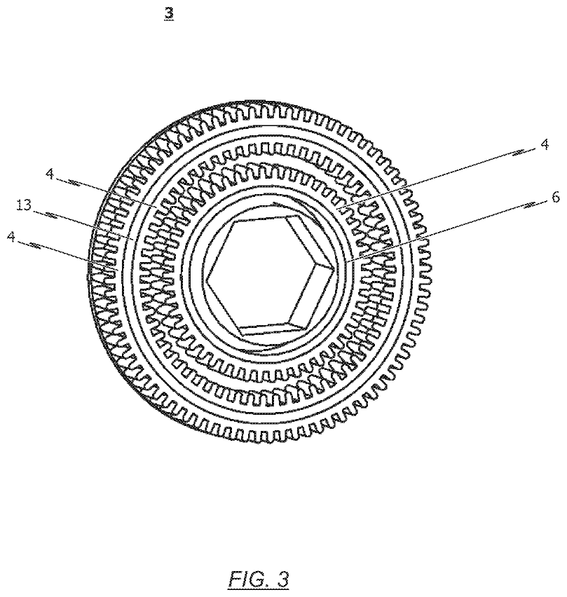

FIGS. 1 and 2 illustrate schematically, respectively, top plan and isometric views of a first exemplary embodiment of the damper apparatus 1 of the disclosure in the opened state, wherein the damper apparatus 1 is configured as a rotary damper. FIG. 3 illustrates schematically and in an isometric view, the second damper component 3 of the exemplary embodiment of the damper apparatus 1 according to the disclosure according to FIG. 1.

The embodiment of the damper apparatus 1 shown schematically in FIG. 1 to FIG. 3 is in particular characterized in that the first damper component 2 is configured as a housing part having an inner cup or well region 8 that is at least substantially circular-cylindrical in cross-section. The housing part with the inner cup or well region 8 serves as the carrier part 7, which forms the ridge structure 5 with the teeth or protrusions.

In addition, the first damper component 2 comprises an annular region 12, which is configured in the circular-cylindrical inner cup or well region 8 such that the inner cup or well region is divided into an outer annular channel and a region that is circular in cross-section and is separated therefrom by the annular region 12. Teeth or protrusions of the ridge structure 5 are formed on the wall that bounds the outer annular channel and on the wall of the annular region that faces inward.

The second damper component 3 (cf. FIG. 3) comprises a blade or rib support 6 that is at least substantially circular-cylindrical in cross-section, to which or at which the blades or ribs of the blade or rib structure 4 are connected or formed, wherein the circular-cylindrical blade or rib support 6 with the blade or rib structure 4 is at least partially or regionally accommodated in the inner well region 8 of the first damper component 2, preferably in an exchangeable manner such that the second damper component 3 with the blade or rib structure 4 is rotatable relative to the first damper component 2, while the at least one tooth or protrusion of the ridge structure 5 is arranged at least partially and/or regionally in an intermeshing manner between two adjacent blades or ribs of the blade or rib structure 4.

The second damper component 3 further comprises an annular blade or rib support 13, which is arranged so as to complement the outer annular channel of the first damper component 2 in such a way that the annular blade or rib support 13 can be at least partially or regionally accommodated in the outer annular channel of the first damper component 2, wherein blades or ribs of the blade or rib structure 4 are connected to or formed at the annular blade or rib support 6 on both sides.

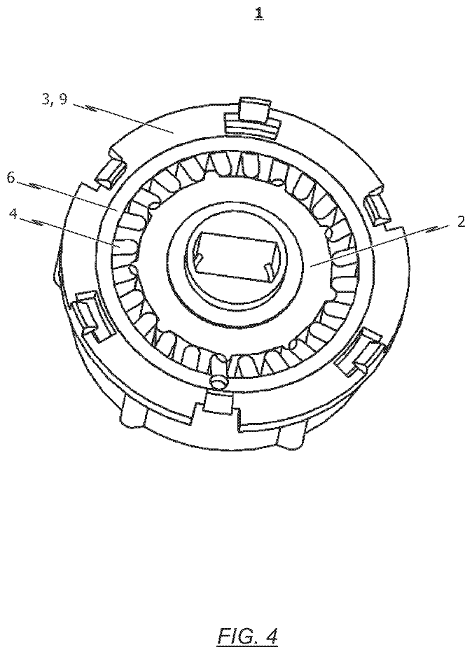

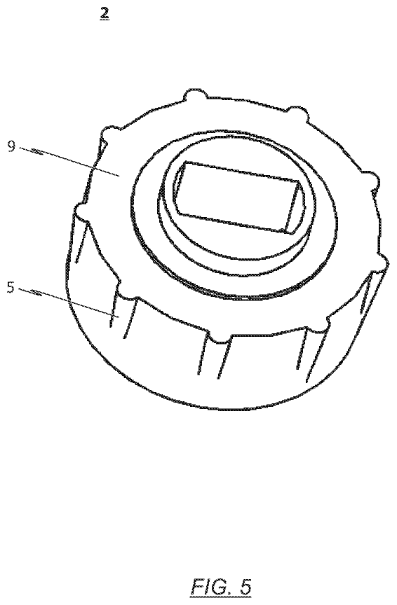

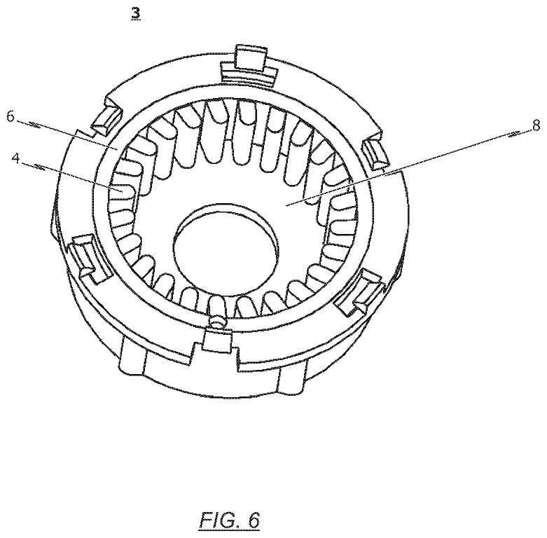

Also in the second exemplary embodiment of the damper apparatus 1 according to the present disclosure, shown schematically in FIG. 4 to FIG. 6, it is provided that this damper apparatus 1 is configured as a rotary damper. FIG. 4 illustrates schematically, an isometric view of a second exemplary embodiment of the damper apparatus 1 of the disclosure in the opened state, wherein the damper apparatus 1 is configured as a rotary damper. FIG. 5 illustrates schematically, an isometric view of the first damper component 2 of the second exemplary embodiment of the damper apparatus 1 according to the disclosure according to FIG. 4, while FIG. 6 illustrates schematically, an isometric view of the second damper component 3 of the second exemplary embodiment.

The second damper component 3 of the damper apparatus 1 is configured as a housing part having an inner well region 8 that is substantially circular-cylindrical in cross section. The housing part with the inner well region 8 serves as a blade or rib support 6, to which or at which the blades or ribs of the blade or rib structure 4 are connected or formed.

Further, in the second exemplary embodiment according to FIG. 4 to FIG. 6, it is provided that the first damper component 2 comprises a carrier part 9 that is at least substantially circular-cylindrical in cross-section, which forms the ridge structure 5 with the at least one tooth or protrusion and is at least partially or regionally accommodated in the inner well region 8 of the second damper component 3, preferably in an exchangeable manner such that the carrier part 9 with the ridge structure 5 is rotatable relative to the second damper component 3, while the at least one tooth or protrusion of the ridge structure 5 is arranged at least partially and/or regionally in an intermeshing manner between two adjacent blades or ribs of the blade or rib structure 4.

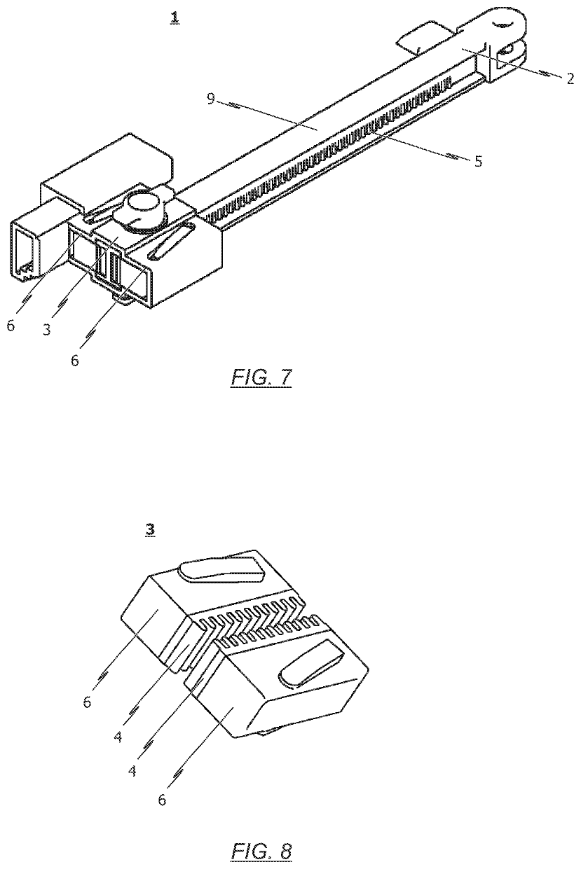

FIG. 7 illustrates schematically and in an isometric view, a third exemplary embodiment of the damper apparatus 1 according to the present disclosure, which is configured as a linear damper, while FIG. 8 illustrates schematically, an isometric view of the second damper component 3 of the third exemplary embodiment of the damper apparatus 1 according to the disclosure according to FIG. 7.

In the exemplary embodiment of the damper apparatus 1 according to the disclosure shown schematically in FIG. 7 and FIG. 8, it is provided that the damper apparatus 1 is configured as a linear damper.

The second damper component 3 comprises two opposing blade or rib supports 6, which are configured so as to form a preferably form-fit and even more preferably at least partially or regionally form-fit sliding guide enabling the translation for a rod-shaped carrier part 9 of the first damper component 2, wherein each blade or rib support 6 of the second damper component 3 comprises a blade or rib structure 4 having a plurality of blades or ribs.

On the other hand, in the exemplary embodiment of the damper apparatus 1 according to the disclosure illustrated in FIG. 7 and FIG. 8, it is provided that the rod-shaped carrier part 9 of the first damper component 2 comprises a ridge structure 5 having a plurality of teeth or protrusions arranged on opposite lateral surfaces of the rod-shaped carrier part 9 in such a way that, when the rod-shaped carrier part 9 is moved by the sliding guide, with simultaneous elastic deflection of the blades or ribs, they pass by one another, in particular in an intermeshing manner.

In particular, in the exemplary embodiment of the damper apparatus 1 according to FIG. 7 and FIG. 8, it is provided that a distance between the two opposing blade or rib supports 6 is preferably variable in order to define a dampening factor of the damper apparatus 1.

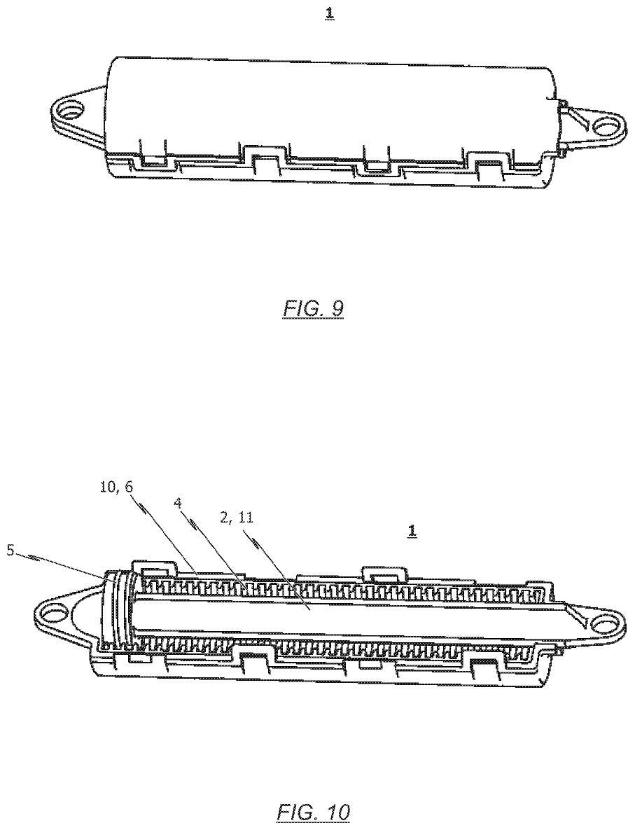

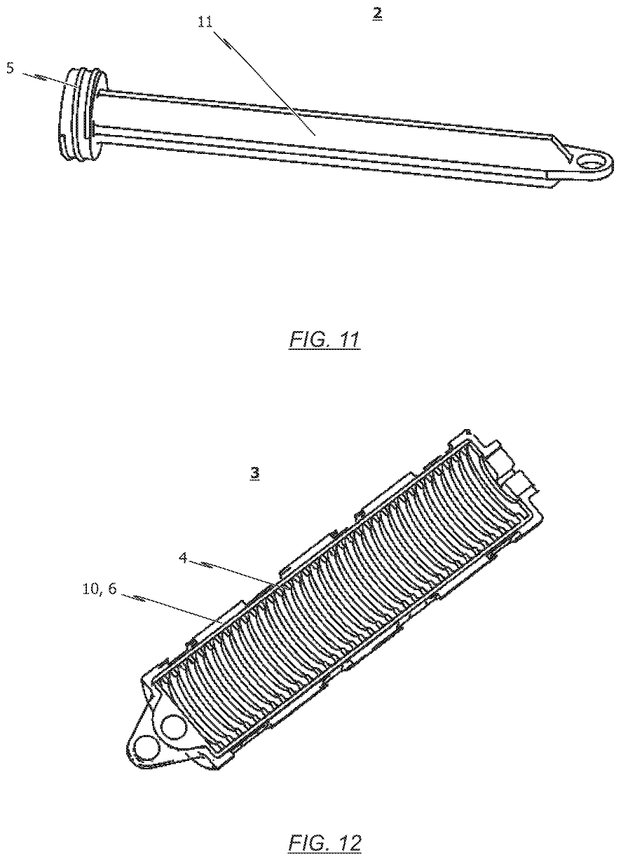

FIG. 9 illustrates schematically and in an isometric view, a fourth exemplary embodiment of the damper apparatus 1 according to the present disclosure, which is configured as a linear damper, while FIG. 10 illustrates schematically, an isometric view of the fourth exemplary embodiment of the damper apparatus 1 according to the present disclosure in the opened state. FIGS. 11 and 12 illustrate, respectively and schematically, isometric views of the first damper component 2 and the second damper component 3 of the fourth exemplary embodiment of the damper apparatus 1 according to the disclosure according to FIG. 9.

In the exemplary embodiment of the damper apparatus 1 schematically shown in FIG. 9 to FIG. 12, it is provided that the damper apparatus 1 is also configured as a linear damper, in which the second damper component 3 is configured as a cylindrical housing part 10 having a cavity that is at least substantially circular-cylindrical in cross-section.

The housing part 10 with the cavity serves as a blade or rib support 6, to which or at which the blades or ribs of the blade or rib structure 4 are connected or formed.

In particular, it is provided that the first damper component 2 comprises a piston 11 that dips at least partially or regionally into the cavity of the cylindrical housing part 10 and comprises a piston rod having a first end region at which a carrier part with the ridge structure 5 that is substantially circular-cylindrical in cross-section is arranged or formed.

Further, it is provided in particular that the piston 11 with the carrier part and the ridge structure 5 can be displaced in the longitudinal direction of the cylindrical housing part 10 relative to the cylindrical housing part 10, while the at least one tooth or protrusion of the ridge structure 5 is arranged at least partially and/or regionally in an intermeshing manner between two adjacent blades or ribs of the blade or rib structure 4.

Specifically, it is provided that the two blade or rib supports 6 lying opposite one another are respectively slidably mounted relative to the rod-shaped carrier portion by way of a guide running obliquely to the direction of movement of the rod-shaped carrier part, and namely in particular such that, upon a movement of the rod-shaped carrier part in a first direction by the sliding guide, the two blade or rib supports 6 are present in a first position, and, upon a movement of the rod-shaped carrier part in a second direction opposite the first direction by the sliding guide, the two blade or rib supports 6 are displaced into a second position and/or are present in a second position, wherein, in the second position of the two blade or rib supports 6, a distance between the two opposing blade or rib supports 6 is greater than in the first position of the two blade or rib supports 6.

As can be seen in particular from the view according to FIG. 10, in this exemplary embodiment of the damper apparatus 1 according to the disclosure, it is provided in particular that the at least one tooth or protrusion of the ridge structure 5 is configured as a screw-like structure, in particular a helix structure, being formed at least partially or regionally on the lateral surface of the circular-cylindrical carrier part.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Damper apparatus
2 Damper component
3 Damper component
4 Blade or rib structure
5 Ridge structure
6 Blade or rib support
7 Housing part
8 Inner well region
9 Carrier part
10 Cylindrical housing part
11 Piston
12 Annular region
13 Blade or rib support

What is claimed is:

1. A damper apparatus (1) for reducing a movement of a second part movable relative to a first part, wherein the damper apparatus (1) comprises the following:
a first damper component (2) fixedly connected or connectable to the first part;
a second damper component (3) fixedly connected or connectable to the second part and is movable, at least partially or regionally, relative to the first damper component (2); and
a dampening mechanism arranged between the first and second damper components (2, 3) and configured such that a movement of the second damper component (3) relative to the first damper component (2) is or can be reduced,
wherein the dampening mechanism comprises a blade or rib structure (4) connected to the first or second damper component (2; 3) with a plurality of protruding regions, which are elastically deflectable at least partially or regionally in a direction of movement of the first damper component (2) relative to the second damper component (3); and
wherein the dampening mechanism comprises a ridge structure (5) connected to the second or first damper component (3; 2) having at least one tooth or protrusion, wherein, at least in a state in which the second damper component (3) is not moved relative to the first damper component (2), the at least one tooth or protrusion of the ridge structure (5) is arranged at least partially or regionally in an intermeshing manner between two adjacent protruding regions of the blade or rib structure (4).

2. The damper apparatus (1) according to claim 1,
wherein the at least one tooth or protrusion of the ridge structure (5) is positioned between two adjacent protruding regions of the blade or rib structure (4) such that, upon a movement of the first or second damper component (2; 3) relative to the second or first damper component (3; 2), at least a portion of the protruding regions of the blade or rib structure (4) is elastically deformed using the at least one tooth or protrusion of the ridge structure (5) while simultaneously converting movement energy into elastic deformation work.

3. The damper apparatus (1) according to claim 1,
wherein the at least one tooth or protrusion of the ridge structure (5) is formed from a material that is harder compared to the material of the protruding regions of the blade or rib structure (4).

4. The damper apparatus (1) according to claim 1,
wherein the protruding regions of the blade or rib structure (4), when viewed in a cross-section of the protruding regions, have a geometry that at least partially or regionally tapers in the direction of the ridge structure (5); and/or
wherein the at least one tooth or protrusion of the ridge structure (5), when viewed in the cross-section of the at least one tooth or protrusion, has a geometry that at least partially or regionally tapers in the direction of the blade or rib structure (4); and/or
wherein the at least one tooth or protrusion of the ridge structure (5) has a shape which, at least regionally, is at least substantially complementary to the shape of the protruding regions of the blade or rib structure (4).

5. The damper apparatus (1) according to claim 1,
wherein the blade or rib structure (4) comprises a blade or rib support (6) which is fixedly connected or connectable to the first or second damper component (3) and the plurality of protruding regions connected to the blade or rib support (6), wherein the blade or rib support (6) is formed from a material that is harder compared to the material of the protruding regions, wherein the blade or rib structure (4) is formed as part of a two-part plastic injection molding process.

6. The damper apparatus (1) according to claim 1,
wherein, in an unloaded state, at least a portion of the protruding regions of the blade or rib structure (4) extends at least substantially in a direction that is at least substantially perpendicular to a direction of movement of the second damper component (3) relative to the first damper component (2); and/or
wherein the at least one tooth or protrusion of the ridge structure (5) extends at least substantially in a direction which is at least substantially perpendicular to the direction of movement of the second damper component (3) relative to the first damper component (2).

7. The damper apparatus (1) according to claim 1,
wherein, in an unloaded state, at least a portion of the protruding regions of the blade or rib structure (4) extends at least substantially obliquely in view of a direction that extends perpendicular to a direction of movement of the second damper component (3) relative to the first damper component (2).

8. The damper apparatus (1) according to claim 1,
wherein the ridge structure (5) is configured such that, between two adjacent teeth or protrusions of the ridge structure (5), a plurality of protruding regions of the blade or rib structure (4) are arranged; and/or
wherein a number of the protruding regions of the blade or rib structure (4) between two adjacent teeth or protrusions of the ridge structure (5) varies, or a number of the teeth or protrusions of the ridge structure (5) between two adjacent protruding regions of the blade or rib structure (4) varies.

9. The damper apparatus (1) according to claim 1,
wherein the first and second damper components (3) are each modular in structure, so that the rib structure (4) and/or the ridge structure (5) are exchangeable as needed and for varying a response behavior and/or a dampening factor of the damper apparatus (1).

10. The damper apparatus (1) according to claim 1,
wherein the damper apparatus (1) is configured as a rotary damper, in which the first damper component (2) is configured as a housing part having an inner well region that is at least substantially circular-cylindrical in cross-section, wherein the housing part with the inner well region (8) serves as a blade or rib support (6), to which or at which the protruding regions of the blade or rib structure (4) are connected or formed, wherein the second damper component (3) comprises a carrier part (9) that is at least substantially circular-cylindrical in cross-section, which forms the ridge structure (5) with the at least one tooth or protrusion and is at least partially or regionally accommodated in the inner well region (8) of the first damper component (2), in an exchangeable manner such that the carrier part (9) with the ridge structure (5) is rotatable relative to the first damper component (2), while the at least one tooth or protrusion of the ridge structure (5) is arranged at least partially and/or regionally in an intermeshing manner between two adjacent protruding regions of the blade or rib structure (4).

11. The damper apparatus (1) according to claim 1,
wherein the damper apparatus (1) is configured as a rotary damper, in which the first damper component (2) is configured as a housing part having an inner well region (8) that is at least substantially circular-cylindrical in cross-section, wherein the housing part with the inner well region (8) serves as a carrier part (9) which forms the ridge structure (5) with the at least one tooth or protrusion, wherein the second damper component (3) comprises a blade or rib support (6) that is at least substantially circular-cylindrical in cross-section, to which or at which the protruding regions of the blade or rib structure (4) are connected or formed, wherein the circular-cylindrical blade or rib support (6) with the blade or rib structure (4) is at least partially or regionally accommodated in the inner well region (8) of the first damper component (2), in an exchangeable manner such that the carrier part (9) with the ridge structure (5) is rotatable relative to the first damper component (2), while the at least one tooth or protrusion of the ridge structure (5) is arranged at least partially and/or regionally in an intermeshing manner between two adjacent protruding regions of the blade or rib structure (4).

12. The damper apparatus (1) according to claim 11,
wherein the first damper component (2) comprises an annular region (12), which is formed in the circular-cylindrical inner well region (8) such that the inner well region (8) is divided into an outer annular channel and a region that is circular in cross-section and is separated therefrom by the annular region (12), wherein the teeth or protrusions of the ridge structure (5) are formed on a wall bordering the outer annular channel and on a wall of the annular region (12) facing inward, and wherein the second damper component (3) further comprises an annular blade or rib support (13), which is arranged so as to complement the outer annular channel of the first damper component (2) in such a way that the annular blade or rib support (6) can be at least partially or regionally accommodated in the outer annular channel of the first damper component (2), wherein protruding regions of the blade or rib structure (4) are connected or formed to or at the annular blade or rib support (6) on both sides.

13. The damper apparatus (1) according to claim 1,
wherein the damper apparatus (1) is configured as a linear damper, wherein the first damper component is configured as a cylindrical housing part (10) having a cavity that is at least substantially circular-cylindrical in cross-section, wherein the housing part (10) with the cavity serves as a blade or rib support (6), to which or at which the protruding regions of the blade or rib structure (4) are connected or formed, wherein the second damper component (3) comprises a piston (11) that dips at least partially or regionally into the cavity of the cylindrical housing part (10) and comprises a piston rod having a first end region at which a carrier part (9) with the ridge structure (5) that is substantially circular-cylindrical in cross-section is arranged or formed, wherein the piston (11) with the carrier part (9) and the ridge structure (5) can be displaced in the longitudinal direction of the cylindrical housing part (10) relative to the cylindrical housing part (10), while the at least one tooth or protrusion of the ridge structure (5) is arranged at least partially and/or regionally in an intermeshing manner between two adjacent protruding regions of the blade or rib structure (4), wherein the at least one tooth or protrusion of the ridge structure (5) is configured as a helix structure, being formed at least partially or regionally on the lateral surface of the circular-cylindrical carrier part.

14. The damper apparatus (1) according to claim 1,
wherein the damper apparatus (1) is configured as a linear damper, in which the first damper component comprises two opposing blade or rib supports (6), which are configured so as to form a form-fit sliding guide enabling translation for a rod-shaped carrier part (9) of the second damper component (3), wherein each blade or rib support (6) of the first damper component (2) comprises a blade or rib structure (4) having a plurality of protruding regions, and wherein the rod-shaped carrier part (9) of the second damper component (3) comprises a ridge structure (5) having a plurality of teeth or protrusions arranged on opposite lateral surfaces of the rod-shaped carrier part in such a way that, when the rod-shaped carrier part is moved by the sliding guide, with simultaneous elastic deflection of the protruding regions, they pass by one another in an intermeshing manner.

15. The damper apparatus (1) according to claim 14,
wherein a distance between the two opposing blade or rib supports (6) is variable in order to define a dampening factor of the damper apparatus (1); and/or
wherein at least one of the two blade or rib supports (6) lying opposite one another is slidably mounted relative to the rod-shaped carrier portion by way of a guide running obliquely to the direction of movement of the rod-shaped carrier part, and such that, upon a movement of the rod-shaped carrier part in a first direction by the sliding guide, the at least one blade or rib support (6) is present in a first position, and, upon a movement of the rod-shaped carrier part in a second direction opposite the first direction by the sliding guide, the at least one blade or rib support (6) is displaced into a second position and/or is present in a second position, wherein, in the second position of the at least one blade or rib support (6), a distance between the two opposing blade or rib supports (6) is greater than in the first position of the at least one blade or rib support (6).

16. The damper apparatus (1) according to claim 1, wherein the plurality of protruding regions are in a form of blades, ribs, or knobs.
